(19) United States
(12) Patent Application Publication
(10) Pub. No.: US 2023/0049409 A1
(43) Pub. Date: Feb. 16, 2023

(54) PROCESS AND INSTALLATION FOR THE DESTRUCTION OF RADIOACTIVE SODIUM

(71) Applicant: FRAMATOME, Courbevoie (FR)

(72) Inventors: Dominique VILLANI, SAINT LAURENT DE MURE (FR); Gérard DEPREZ, SAINT GENIS LAVAL (FR); Olivier DOUCET, LYON (FR)

(21) Appl. No.: 17/870,784

(22) Filed: Jul. 21, 2022

(30) Foreign Application Priority Data
Jul. 22, 2021 (FR) FR 21 07922

(51) Int. Cl. G21C 3/60; G21C 1/02; G21C 19/18; G21C 19/303

(52) U.S. Cl. CPC G21C 3/60; G21C 1/022; G21C 19/18; G21C 19/303

(57) ABSTRACT

An installation is for the destruction of radioactive metallic sodium and includes a reaction vessel containing an aqueous solution, the reaction vessel having an aqueous solution outlet; a sodium feed circuit configured for feeding liquid metallic sodium into the reaction vessel; a liquid effluent treatment unit, comprising a drain tank and a drain line fluidically connecting the aqueous solution outlet to the drain tank; a gas treatment unit configured for diluting the gases and releasing the diluted gases into the atmosphere, the drain tank having a gas outlet fluidically connected to the gas treatment unit; an inert gas feed unit configured for feeding the drain tank.

The present disclosure relates in general to installations for the destruction of radioactive metallic sodium, typically coming from fast-neutron nuclear reactors.

### BACKGROUND

It is possible to arrange such an installation as shown in FIG. 1. The installation includes a liquid metallic sodium storage tank 3, with a capacity provided for one day of operation of the installation at the nominal capacity thereof.

The liquid metallic sodium storage tank 3 receives the sodium to be treated and feeds a sodium feed circuit 5 by means of an electromagnetic pump 7.

The sodium feed circuit 5 mainly comprises a load tank 9 and a metering pump 11. The metering pump is placed at a lower level than the load tank 9, and the intake thereof is fed by gravity from the load tank 9.

The sodium coming from the sodium storage tank 3 fills the load tank 9 up to an overflow 13, which returns the excess sodium to the sodium storage tank 3.

The sodium level in the load tank is thus maintained at a substantially constant level, which guarantees a constant pressure at the intake of the metering pump 11.

A sodium filter 15 is interposed on the line 17 connecting the electromagnetic pump to the load tank 9. Same is used to check the cleanliness of the sodium coming from the sodium storage tank 3.

The installation 1 further comprises a reaction vessel 19 containing an aqueous sodium hydroxide solution. The sodium discharged by the metering pump 11 is injected from above into the reaction vessel 19 and reacts with a jet of sodium hydroxide. The jet of sodium hydroxide comes from a nozzle 21 placed in the reaction vessel 19 and fed by a recirculation circuit 23. This arrangement guarantees a complete reaction of the sodium with the aqueous solution.

The sodium is thus converted into sodium hydroxide, the reaction being accompanied by a release of gaseous hydrogen. The sodium hydroxide accumulates in the lower part of the reaction vessel, the hydrogen being discharged toward a hydrogen treatment circuit 25.

A heat exchanger 27 is interposed along the recirculation circuit 23. Same is connected to a cold unit 29. The heat exchanger 27 evacuates the heat energy released by the reaction of the sodium with the aqueous solution.

Furthermore, a line 31 for supplying demineralized water is connected to the recirculation circuit 23. The line 31 allows a suitable quantity of demineralized water to be injected into the reaction vessel so as to keep the molarity of the sodium hydroxide within the reaction vessel substantially constant.

The hydrogen treatment circuit 25 is connected to the lid of the reaction vessel 19 and opens into the blanket of said vessel. Same successively comprises a gas scrubber 33, a condenser 35, a heater 37 and a THE (in French: Très Haute Efficacité = very high efficiency) filter 39. The hydrogen treatment circuit, downstream of the THE filter, is connected to a process ventilation 41.

In the process ventilation 41, the hydrogen from the reaction vessel 19 is diluted in a ventilation duct, to a concentration which excludes any risk of explosion. The concentration of hydrogen in the gas coming from the reaction vessel is about 100%. In the process ventilation, hydrogen is diluted to a concentration of about 1% during normal operation. The ventilation duct wherein the dilution takes place is equipped with instrumentation apt to confirm the efficiency of the dilution, by monitoring both the gas flow-rate through the duct and the concentration of hydrogen.

An inert gas feed 43 is connected to the lid of the reaction vessel 19. Said feed is designed to render the reaction vessel 19 and the hydrogen treatment circuit 25 inert, before starting the conversion reaction for sodium. In the event of a shut-down of the installation, the inert gas feed 43 provides the evacuation of hydrogen.

The installation further includes a treatment unit 45 for liquid effluents. The unit 45 comprises a tank for draining and storing the aqueous solution 47. A drain line 49 connects an overflow outlet 51 of the reaction vessel 19 to the drain and storage tank 47. A purge valve 52 is interposed along the drain line 49 immediately downstream of the outlet 51. Same is used to separate gaseous hydrogen from the sodium hydroxide, gaseous hydrogen being returned to the blanket of the reaction vessel 19.

Furthermore, the drain line 49 comprises an expansion loop 53, forming a siphon which is used to limit the transfer of hydrogen from the blanket of the reaction vessel 19 toward the drain and storage tank 47. A liquid plug is formed in the expansion loop, blocking gas transfers between the vessel 19 and the tank 47.

The drain and storage tank 47 has a large capacity. Same can store several days of production from the installation 1. The tank is dimensioned so as to be able to further receive all the aqueous solution present in the installation, in particular in the reaction vessel 19, in the scrubber 33 and in the different circuits filled with aqueous solution.

The liquid effluent treatment unit 45 further comprises a lift pump 50 and a line 54 designed to fill the reaction vessel 19 and the drain line 49 with aqueous solution from the drain and storage tank 47. The lift pump 50 also allows the aqueous solution to be transferred out of the installation.

Such an installation is satisfactory for treating significant quantities of liquid metallic sodium. However, same has the drawback of being complex and large, so that the cost of treatment is excessively high when the daily throughput to be treated is limited.

### SUMMARY

In this context, the present disclosure aims to provide an installation which is more economical and better suited for a reduced treatment capacity.

To this end, the present disclosure provides an installation for destroying radioactive metallic sodium, comprising: a reaction vessel containing an aqueous solution, the reaction vessel having an aqueous solution outlet; a sodium feed circuit configured to feed liquid metallic sodium into the reaction vessel; a liquid effluent treatment unit, comprising a drain tank and a drain line fluidically connecting the aqueous solution outlet to the drain tank; a gas treatment unit configured for diluting the gases and release the diluted gases into the atmosphere, the drain tank having a gas outlet fluidically connected to the gas treatment unit; an inert gas feed unit, configured for feeding an inert gas into the drain tank.

Thus, the blanket of the drain tank is filled with inert gas.

No explosion can be caused by hydrogen coming from the reaction vessel and flowing into the drain tank through the drain line.

Hydrogen is continuously evacuated toward the gas treatment unit. The evacuation is achieved due to the fact that the drain tank is connected to the inert gas feed unit.

The latter continuously maintains an overpressure of inert gas inside the drain tank and/or continuously sweeps inert gas in the blanket of this tank.

As a result, it is not necessary to provide an expansion loop or a siphon along the drain line for forming a plug of aqueous solution for preventing the circulation of hydrogen from the reaction vessel into the drain tank.

In this way, the total height of the installation is reduced. In the installation shown in FIG. 1, the height of the expansion loop is dimensioned by the internal pressure of the reaction vessel. Same is thus several meters high, and the building housing the installation has to have a sufficient height to allow the installation to be installed.

The total cost of the installation is reduced accordingly.

The installation may further have one or more of the following features, taken individually or in all technically possible combinations:
the aqueous solution outlet is an overflow outlet;
the installation comprises a control unit configured for maintaining an inert gas pressure in the drain tank above a predetermined minimum;
the controller controls the inert gas feed unit providing inert gas sweeping in the drain tank, with an inert gas flow-rate within a predetermined range;
the drain line is configured for emptying completely into the drain tank, by gravity;
the installation comprises a hydrogen treatment circuit connected to the reaction vessel, equipped with at least one gas scrubber, the drain tank having a storage capacity comprised between: a minimum volume equal to a nominal volume of aqueous solution contained in the reaction vessel plus a nominal volume of aqueous solution contained in the gas scrubber; and a maximum volume equal to the production of sodium hydroxide over a period of 6 hours;
the installation includes an aqueous solution storage tank with a storage capacity greater than one production day of the installation with nominal treatment capacity;
the installation comprises a transfer member having an intake connected to the drain tank and a discharge connected to the aqueous solution storage tank;
the drain tank is at least partially located below ground level and the aqueous solution storage tank is located above ground level.

The present disclosure also provides a process of destruction of radioactive metallic sodium, comprising the following steps: feeding liquid metallic sodium into a reaction vessel containing an aqueous solution, the reaction vessel having an aqueous solution outlet; collecting the aqueous solution from the reaction vessel in a drain tank, the aqueous solution flowing through a drain line from the aqueous solution outlet right to the drain tank; feeding an inert gas into the drain tank; diluting the gases from the drain tank, and releasing the diluted gases into the atmosphere.

### BRIEF SUMMARY OF THE DRAWINGS

Other features and advantages of the present disclosure will emerge from the detailed description given below, as an indication only and by no means limited to, with reference to the enclosed figures, among which:

FIG. 1 is a schematic representation of an example of a sodium destruction installation which is not according to the present disclosure;

FIG. 2 is a schematic representation sodium destruction installation according to the present disclosure;

FIG. 3 is an enlarged representation of a detail of FIG. 2, for a variant embodiment of the sodium destruction installation which is not according to the present disclosure.

### DETAILED DESCRIPTION

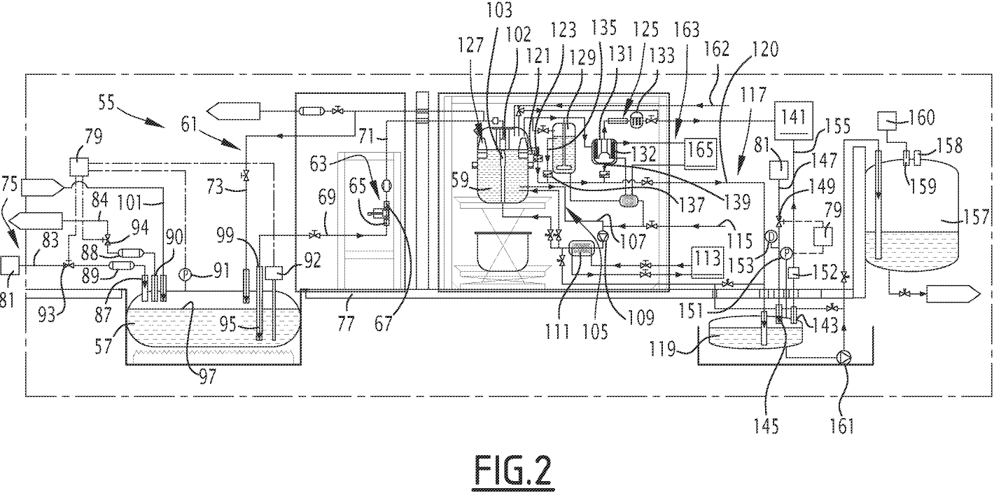

The installation 55 shown in FIG. 2 is designed for the destruction of radioactive sodium, typically coming from a fast-neutron reactor such as Phoenix or Super Phoenix or from a test loop.

It is designed more particularly for destroying the metallic sodium used as a heat-transfer fluid in fast-neutron reactors, by conversion to sodium hydroxide.

This installation uses the NOAH process, which was developed by the Atomic Energy Commission.

The principle of the process is to inject small amounts of liquid sodium into a high flow-rate aqueous solution stream, the operation taking place inside a sealed vessel. Because the reaction is highly exothermic, the aqueous solution is cooled continuously, temperature thereof being maintained at about 40° C.

The reaction of sodium with water from the aqueous solution produces sodium hydroxide and hydrogen. The sodium hydroxide is rapidly dispersed in the aqueous solution, without giving rise to a violent reaction. The sodium hydroxide concentration in the reaction vessel is kept substantially constant by injection of demineralized water. The concentration is continuously adjusted e.g. to ten moles/liter.

The hydrogen generated is released into the atmosphere, after dilution and purification.

The installation 55 comprises a tank 57 for storing liquid metallic sodium.

The installation 55 comprises a reaction vessel 59 containing an aqueous solution.

The installation 55 further comprises a sodium feed circuit 61, configured for feeding liquid metallic sodium into the reaction vessel 59.

The sodium feed circuit 61 comprises a sodium circulation member 63.

The sodium circulation member 63 is a pump, and more precisely a metering pump.

Same is of any suitable type. Same is e.g. a diaphragm pump.

The circulation member 63 has an intake 65 in fluidic communication with the sodium storage tank 57 and a discharge 67 in fluidic communication with the reaction vessel 59.

More precisely, the sodium feed circuit 61 comprises an intake line 69 connecting the intake 65 of the sodium circulation member to the sodium storage tank 57. The circuit 61 further comprises a discharge line 71 connecting the discharge 67 of the sodium circulation member 63 to the reaction vessel 59.

The sodium feed circuit 61 further comprises a sodium return line 73 fluidically connecting the delivery line 71 to the sodium storage tank 57.

The installation 55 further comprises an inert gas feed unit 75, configured for feeding an inert gas into the sodium storage tank 57.

The inert gas is typically nitrogen.

The sodium storage tank 57 is located at a first level with respect to the ground.

As described below, the installation 55 preferentially comprises only one level, the equipment resting on a raft 77. The ground level considered here corresponds e.g. to the level of the raft 77.

The circulation member 63 is situated at a second level with respect to the ground, higher than the first level, i.e. higher than the level of the tank 57.

This means that the intake 65 of the circulation member 63 is situated higher than the storage tank 57, and in particular higher than the free surface of the liquid metallic sodium stored in the storage tank 57 when the latter is filled to the maximum level thereof.

The installation 55 advantageously comprises a controller 79, controlling the inert gas feed unit 75 so as to control an inert gas pressure in the sodium storage tank 57, so that the pressure at the intake 65 of the sodium circulation member 63 is maintained within a predetermined range.

Maintaining the intake pressure of the sodium circulation member within a predetermined range contributes to ensuring that the sodium flow-rate delivered by the circulation member 63 to the reaction vessel 59 is precisely controlled. This point is essential for controlling the reaction of sodium with the aqueous solution and for preventing the runaway reaction thereof.

The predetermined pressure range is preferably [0, 100] mbar effective and the maximum pressure must not induce transfer by siphoning toward the reaction vessel, the pump being switched off.

To this end, the inert gas feed unit 75 comprises a source of inert gas 81 fluidically connected by an inert gas line 83 to the storage tank 57.

Same also comprises a discharge line 84, fluidically connecting the blanket of the storage tank 57 to a gas treatment unit (not shown).

The inert gas source 81 is e.g. an inert gas distribution network. As a variant, it is a high-pressure inert gas storage bottle.

The inert gas source 81 supplies the line 83 with the inert gas at a pressure greater than the predetermined pressure range, e.g. 400 mbar effective. Such pressure typically corresponds to the intake pressure of the metering pump 63, plus the head between the sodium level in the tank 57 and the intake 65 of the circulation member 63.

The inert gas feed line 83 is connected to a tap-off 87 supported by the upper part of the storage tank 57 and opening into the blanket of the tank. A sodium vaportrap 89 is installed on the line 83.

The discharge line 84 is connected to a tap-off 90 supported by the upper part of the storage tank 57 and opening into the blanket of the tank. A sodium vapor trap 88 is installed on the line 84. The gas treatment unit allows the gases from the tank 57 to be discharged into the environment after purification.

The inert gas feed unit 75 comprises a measurement 91 of the gas pressure in the blanket of the storage tank 57. Such measurement is of any suitable type. The pressure measurement 91 informs the controller 79 and sends the measured pressure values to the controller.

The sodium storage tank 57 is advantageously equipped with a sodium level measurement 92. Such measurement is of any suitable type. The sodium level measurement 92 informs the controller 79 and sends the measured sodium level values to the controller.

Furthermore, the inert gas feed line 83 comprises a control member 93 controlled by the controller 79. The control member 93 is interposed on the line 83 and controls the flow-rate of inert gas delivered to the storage tank 57 via the line 83. Similarly, a control member 94, controlled by the controller 79, is interposed on the discharge line 84.

The control members 93 and 94 are e.g. controlled valves.

The control members 93 and 94 are controlled by the controller 79 using the measurement 91 of the gas pressure in the blanket of the storage tank 57 and, if appropriate, the measurement of the sodium level 92.

More precisely, the controller 79 controls the control members 93 and 94 so as to maintain the gas pressure in the blanket of the tank within a predetermined gas pressure range.

The controller 79 selects said gas pressure range to be equal to the intake pressure range of the circulation member plus the head between the sodium level in the tank 57 and the intake of the circulation member 63.

If the sodium level in the tank is substantially constant or changes slightly, the controller 79 will take into account a substantially constant head for determining the gas pressure range.

Otherwise, the controller 79 uses the sodium level measurement 92 for determining the head between the sodium level in the tank 57 and the intake of the circulation member 63.

Indeed, the head between the sodium level in the tank 57 and the intake of the circulation member 63 varies with the sodium level in the tank 57.

The sodium storage tank 57 is impermeable to the inert gas and all the lines opening into the blanket of the tank 57 are equipped with a cut-off member making it possible to prevent the leakage of inert gas toward said lines when the circulation member 63 is in operation.

Advantageously, the intake line 69 is configured for emptying completely into the sodium storage tank 57, by gravity.

In other words, the feed line 69 does not have a siphon, or a U-shaped portion, wherein the liquid metallic sodium could stagnate when the circulation member 63 is stopped.

In contrast, when the circulation member 63 is stopped, all the sodium contained in the line 69 returns by gravity to the storage tank 57.

Similarly, the return line 73 is configured for emptying completely into the sodium storage tank 57, by gravity.

In particular, the intake line 69 comprises an end portion 95 oriented so as to dip into the liquid metallic sodium contained in the sodium storage tank 57 through a free surface 97 of the liquid metallic sodium.

In other words, the end part 95 of the intake line is a tap-off 99 connected to the upper part of the tank 57 and dipping into the liquid metallic sodium. The tap-off 99 is typically substantially vertical.

The outlet of the liquid metallic sodium toward the circulation member 63 is thus done from the top of the storage tank 57 and not from the bottom, which contributes to reducing the risks of leakage from the tank.

The installation 55 further comprises a line 101 for filling the storage tank 57 with sodium.

The line 101 is connected to a large-capacity storage containing the stock of liquid metallic sodium to be destroyed, or to a small-capacity drain installation.

Typically, the sodium storage tank 57 has a storage capacity greater than or equal to a minimum value equal to one day of treatment capacity of the installation plus the volume of sodium likely to be contained in the feed circuit 61.

The sodium storage tank 57 preferentially has a storage capacity of less than or equal to two days of treatment capacity of the plant.

Advantageously, the sodium storage tank 57 is at least partially located below ground level, which contributes to reducing the total height of the installation 55.

The sodium storage tank 57 is a horizontal axis tank, typically a horizontal axis cylindrical tank.

It has e.g. an axial length on the order of 2.5 m and a section of the order of 0.5 m² perpendicular to the axis thereof.

Arranging such a tank with the horizontal axis thereof is more advantageous than placing the same tank with the vertical axis thereof.

Indeed, when a given volume of sodium is taken from said tank, the difference in level is lesser if the tank is arranged with the horizontal axis than if same is arranged with the vertical axis thereof.

In other words, the section of the tank, taken perpendicular to the vertical direction, is larger when the tank has the horizontal axis thereof than when same has the vertical axis thereof, as long as the volume of liquid sodium stored is greater than a minimum volume.

In this way, a substantially constant pressure is obtained at the intake of the circulation member 63.

The reaction vessel 59 comprises a sodium injection nozzle 102 configured for ejecting the sodium downwards. This nozzle is connected to the discharge line 71.

The aqueous solution contained in the reaction vessel 59 is typically sodium hydroxide.

The reaction vessel 59 comprises a nozzle 103 for ejecting aqueous solution, placed substantially under the sodium injection nozzle 102. The aqueous solution ejection nozzle 103 ejects the aqueous solution upwards, so that the aqueous solution jet meets the sodium injected through the sodium injection nozzle 102.

The nozzle 103 is fed by a recirculation and cooling circuit 105. The circuit 105 comprises a duct 107, an upstream end of which is tapped off onto a side wall of the reaction vessel 59. The downstream end of the duct 107 is connected to the nozzle 103. The circuit 105 further comprises a recirculation pump 109 discharging the aqueous solution toward the nozzle 103.

The circuit 105 further comprises an exchanger 111, one side of which is interposed on the duct 107. The other side is connected to a cold unit 113, thus making it possible to cool the aqueous solution which flows in the recirculation and cooling circuit 105.

A demineralized water supply line 115 is connected to the duct 107. Same is connected to a demineralized water distribution network or a demineralized water reserve. Same makes it possible to dilute the aqueous solution contained in the reaction vessel 59 so as to maintain the concentration of the sodium hydroxide at a predetermined value. The demineralized water supplied via the line 115 is injected into the line 107 and mixed with the aqueous solution which flows through the recirculation and cooling circuit 105.

The installation 55 further comprises a liquid effluent treatment unit 117, with a drain tank 119 and a drain line 120 which fluidically connects an aqueous solution outlet 121 from the reaction vessel 59 to the tank 119.

The aqueous solution outlet 121 is typically an overflow outlet.

In other words, the drain line 120 is connected to an overflow of the reaction vessel 59, the aqueous solution contained in the reaction vessel 59 flowing through the overflow into the line 120 when the level of aqueous solution in the reaction vessel exceeds the level of the overflow 121.

A purge 123 is interposed along the drain line 120, immediately downstream of the outlet 121.

Advantageously, the drain line 120 is configured for emptying entirely by gravity into the drain tank 119.

In other words, there is no expansion loop or siphon along the drain line 120, wherein a plug of aqueous solution could be formed.

The installation 55 further comprises a hydrogen treatment circuit 125, connected to the reaction vessel 59.

The hydrogen treatment circuit 125 includes a hydrogen filter 127, placed inside the reaction vessel 59.

The hydrogen treatment circuit 125 further comprises a gas scrubber 129. A gas inlet of the gas scrubber 129 is fluidically connected to the hydrogen filter 127.

The hydrogen treatment circuit 125 further comprises a condenser 131 placed downstream of the gas scrubber 129. A gas outlet of the scrubber 129 is connected to a gas inlet of the condenser 131. The condenser 131 is equipped with a coil 132, wherein refrigerated water flows.

The hydrogen treatment circuit 125 comprises a THE (very high efficiency) filter 133, placed downstream of the condenser 131. A gas outlet of the condenser 131 is connected to a gas inlet of the THE filter 133.

The scrubber 129 contains a volume of aqueous solution. The scrubber 129 comprises an overflow outlet for the aqueous solution, connected to the drain line 120 by an outlet line 135 on which a purge valve 137 is interposed.

The condenser 131 has at the bottom point thereof an outlet for the aqueous solution, connected by an outlet line 139 to the drain line 120. A purge valve is interposed on the outlet line 139.

The installation 55 further comprises a gas treatment unit 141, configured for diluting the gases and releasing the diluted gases into the atmosphere.

An outlet of the THE filter is connected to the gas treatment unit 141.

The gas treatment unit 141 comprises a duct (not shown) wherein the gases from the hydrogen treatment circuit 125 are diluted in such a way that the concentration of hydrogen in the diluted gas is less than a predetermined concentration, thus excluding any risk of explosion.

In practice, the gases coming from the hydrogen treatment circuit 125 contain about 100% hydrogen during the operation of the installation. In the gas treatment unit 141, the gases are diluted to a concentration of hydrogen of about 1%.

Due to the absence of expansion loop in the drain line 120, it is possible that hydrogen may come out of the reaction vessel 59 through the aqueous solution outlet 121 and flow right to the drain tank 119.

Advantageously, the drain tank 119 has a gas outlet 143 fluidically connected by a line 155 to the gas treatment unit 141.

The gas outlet 143 is provided in the upper part of the tank 119 and opens into the blanket of the tank 119.

Moreover, the inert gas feed unit 75 is configured for feeding inert gas to the drain tank (119).

The installation comprises a control member 152 configured for maintaining an inert gas pressure above a predetermined minimum in the drain tank 119.

The control member 152 is a backpressure regulator installed on the line 155 to keep the blanket of the tank 119 under an inert gas pressure.

The backpressure regulator 152 is a valve device which regulates the pressure of the fluid upstream of said backpressure regulator. In other words, the backpressure regulator is a restriction controlled by the upstream pressure level.

The backpressure regulator 152 is calibrated for maintaining a pressure greater than said minimum in the tank 119. Said minimum is between 10 and 100 mbar effective, preferentially between 20 and 60 mbar effective and is equal to e.g. 40 mbar effective.

Furthermore, the controller 79 is configured for controlling the inert gas feed unit 75 so as provide an inert gas sweeping inside the tank 119, with an inert gas flow-rate within a predetermined range.

For this purpose, the drain tank 119 comprises an inert gas inlet 145 arranged in the upper part of the tank. This inlet 145 is connected to the inert gas source 81 by a line 147 on which an adjustment member 149 is interposed.

The regulating member 149 controls the inert gas flow-rate delivered to the drain tank 119 via the line 147. Same is controlled by the controller 79.

The regulating member 149 is e.g. an adjustable valve.

Moreover, the drain tank 119 is equipped with a gas pressure measurement 151. The measurement 151 supplies the controller 79 with the measured pressure values.

Furthermore, the liquid effluent treatment unit 117 is preferentially equipped with a flowmeter 153 configured for measuring the flow-rate of the gas flowing in the blanket of the tank 119.

The controller 79 controls the control member 149 as a function of the flow-rate-values measured by the flowmeter 153 so as to maintain the gas flow-rate within a predetermined range.

The predetermined gas flow-rate range is e.g. [0.1; 10] Nm3/h, preferentially [0.2; 5] Nm3/h, more preferentially [0.5; 1] Nm3/h.

The controller 79 is preferentially programmed to adapt the gas flow-rate to the sodium hydroxide transfer rate toward the sodium hydroxide storage tank 157, which will be described further down. The gas flow-rate is thus increased to maintain the pressure in the blanket of the tank by compensating for the increase in the gas volume related to the transfer of sodium hydroxide.

According to the variant illustrated in FIG. 2, the flowmeter is installed on the line 147. In such a case, the controller 79 is programmed to control the control unit 149 not only by using the measurement supplied by the flowmeter 153 but also by using the pressure measurement 151.

The degree of opening O of the control unit 149 e.g. is determined using the following equation:

$$\text{O = K1*} \left({\text{P}}_{\text{mes}} - {\text{P}}_{\text{ref}}\right) + \text{K} 2 * \left({\text{Q}}_{\text{mes}} - {\text{Q}}_{\text{ref}}\right) + \text{K} 3$$

Where K1, K2 and K3 are predetermined constants, P_{ref} is a reference value for the gas pressure in the tank 119, Q_{ref} is a reference value for the gas flow-rate entering the blanket of the tank 119, Pₘₑₛ is the value supplied by the gas pressure measurement 151, Qₘₑₛ is the value supplied by the flowmeter 153.

In a variant, the flowmeter 153 is installed so as to measure the gas flow-rate in the line 155 connecting the gas outlet 143 of the tank to the gas treatment unit 141.

In such a configuration, the controller 79 controls the control unit 149 using the measurement supplied by the value supplied by the flowmeter 153, without using the pressure measurement 151.

Thus, the blanket of the drain tank is filled with inert gas.

The hydrogen coming from the reaction vessel 59 and flowing - in an incidental situation - into the drain tank 119 via the drain line 120, cannot cause an explosion.

Hydrogen is continuously evacuated toward the gas treatment unit 141. This evacuation is achieved due to the fact that the drain tank 119 is connected to the inert gas feed unit 75. The latter continuously maintains an overpressure of inert gas in the drain tank 119 and continuously sweeps inert gas in the blanket of said tank.

Maintaining the drain tank 119 under overpressure contributes to reduce the risk of air penetrating inside the tank.

The drain tank 119 has a storage capacity comprised between:
a minimum volume equal to a nominal volume of aqueous solution contained in the reaction vessel 59, plus a nominal volume of aqueous solution contained in the gas scrubber 129; and
a maximum volume equal to the production of sodium hydroxide over a period of 6 hours.

In other words, the drain tank 119 is dimensioned for receiving the volume of aqueous solution contained in the reaction vessel 59, and the volume of aqueous solution contained in the recirculation and cooling circuit 105, in the drain line 120, and in the hydrogen treatment circuit 125. Same is not dimensioned, however, for storing the volume of aqueous solution resulting from the operation of the installation 55 for a significant period of time, e.g. one day.

To this end, the installation 55 comprises an aqueous solution storage tank 157 with a storage capacity greater than one production day of the installation at nominal treatment capacity.

The aqueous solution storage tank 157 e.g. has a storage capacity of one week of production at nominal treatment capacity.

If need be, the installation comprises a plurality of aqueous solution storage tanks.

The drain tank 119 e.g. has a storage capacity of about 1 m³ of aqueous solution. The installation 55 further comprises three tanks 157 for storing aqueous solution, each with a volume of 30 m³.

The storage tank 157 has an air inlet 158 through which the blanket of the storage tank 157 communicates with the atmosphere of the room where the tank 157 is installed. The storage tank 157 further has a gas outlet 159 opening into the blanket of the tank 157. The gas outlet 159 is connected to the ventilation system 160 of the building. The ventilation system is of the conventional type. Same is different from the gas treatment unit 141 towards which, the gases from the process which contain hydrogen are directed.

The drain tank 119 is at least partially located below ground level. On the other hand, the or each aqueous solution storage tank 157 is located above ground level.

The installation 55 further comprises a transfer member 161 having an intake which is fluidically connected to the drain tank 119 and a discharge which is fluidically connected to the aqueous solution storage tank 157.

The use of a small capacity drain tank, at least partially buried, and a large capacity aqueous solution storage tank, located above the ground, contributes to reducing the total height of the installation.

It then becomes possible to arrange the installation 55 on a single level.

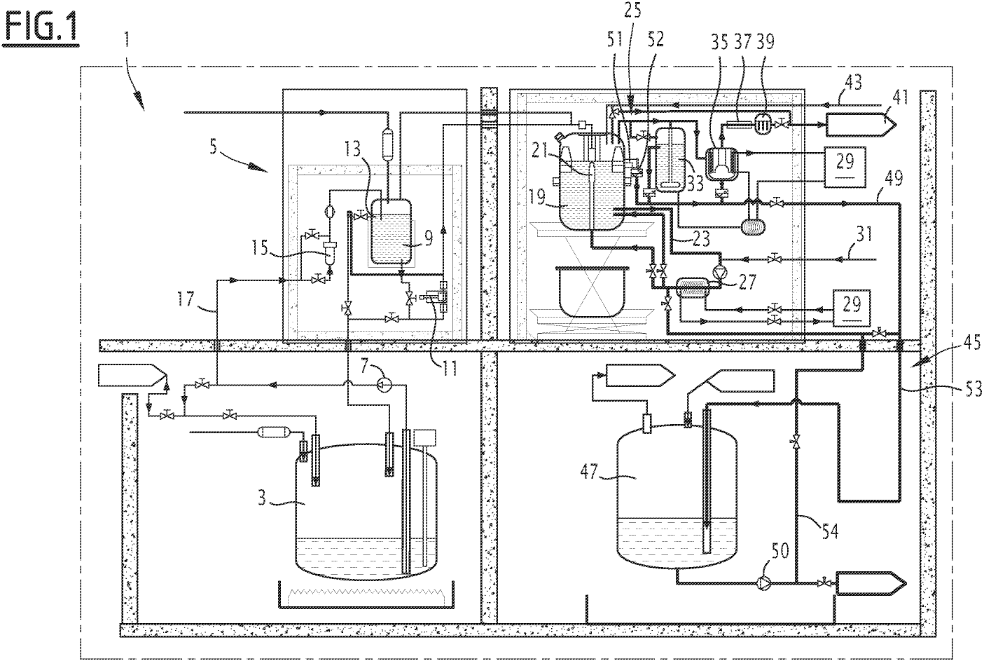

In the installation illustrated in FIG. 1, the equipment is arranged on two levels. The sodium storage tank 3 and the aqueous solution storage and drain tank 47 are arranged at ground level, the reaction vessel 19 being located at a higher level.

As a result, the cost of Civil Engineering for the sodium destruction installation 55 shown in FIG. 2, is reduced.

The inert gas feed unit 75 includes a line 162 connected to the blanket of the reaction vessel 59. Such line is designed to inert the reaction vessel and the hydrogen treatment circuit before starting the installation.

The installation 55 further comprises a circuit 163 feeding chilled water into the coil 132. The circuit 163 is connected to a chiller unit 165.

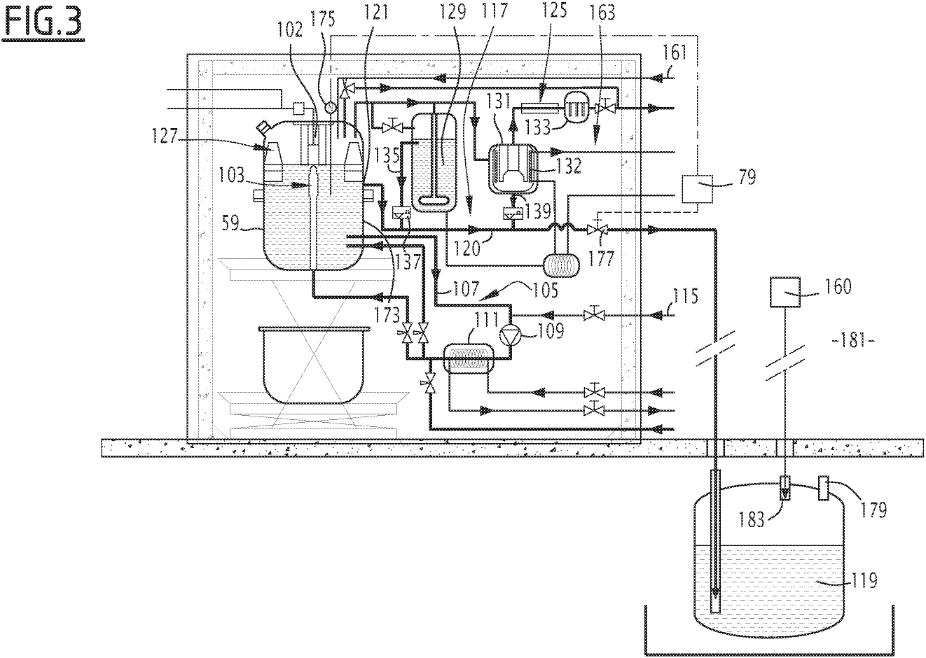

A variant of the installation 55 will now be described, with reference to FIG. 3. Only the points by which the installation of FIG. 3 differ from the installation of FIG. 2 will be discussed in detail below.

Elements which are identical or have the same function will be indicated by the same references.

In the variant shown in FIG. 3, which is not according to the present disclosure, the aqueous solution outlet 121 of the reaction vessel 59 is not an overflow outlet. The aqueous solution outlet 121 is submerged and opens below a nominal level of aqueous solution into the reaction vessel 59.

Typically, the aqueous solution outlet 121 is a tap-off, provided in a side wall 173 of the reaction vessel 59, below the nominal level of aqueous solution.

In such a case, the reaction vessel 59 advantageously comprises a measurement of the level of aqueous solution 175. The level measurement is of any suitable type. Same measures the level of aqueous solution in the reaction vessel 59. Same sends the measured values to the controller 79.

The drain line 120 further comprises a regulating closing member 177.

The closing member 177 is interposed on the drain line 120 and makes it possible to modulate the flow section provided for the aqueous solution flowing through the drain line 120.

The closing member 177 is e.g. a regulating valve.

The controller 79 controls the closing member 177 by using the level values measured by the level measurement 175. The controller 79 controls the closing member 177 so as maintain the level of aqueous solution in the reaction vessel 59 within a predetermined range.

When the aqueous solution level is within the predetermined range, the aqueous solution outlet 121 is submerged.

Accordingly, it is not necessary to connect the drain tank 119 to the inert gas feed unit 75. It is not necessary either to connect the drain tank 119 to the gas treatment unit 141.

In fact, because the outlet 121 is constantly submerged, there is no hydrogen flowing from the reaction vessel 59 right to the drain tank 119 via the drain line 120.

On the other hand, the drain tank 119 comprises a gas inlet 179 putting the blanket of the storage tank 119 in fluidic communication with the atmosphere 181 of the premises wherein the tank 119 is installed.

The drain tank 119 further comprises a gas outlet 183 putting the blanket of the tank 119 in communication with the ventilation 160 for the building.

According to a second aspect, the present disclosure relates to a process of destruction of radioactive sodium, typically coming from a fast-neutron reactor.

Such process is especially suited for the installation 55 described above.

Conversely, the installation 55 is specially designed for implementing the process which will be described.

The process comprises the following steps:
Transferring the liquid metallic sodium to be treated into a liquid metallic sodium storage tank 57 located at a first level with respect to the ground.
Feeding sodium into a reaction vessel 59 containing an aqueous solution, via a sodium feed circuit 61, the sodium feed circuit 61 comprising a sodium circulation member 63 located at a second level with respect to the ground and higher than the first level, where the circulation member 63 has an intake 65 in fluidic communication with the sodium storage tank 57 and a discharge 67 in fluidic communication with the reaction vessel 59;
Feeding an inert gas into the sodium storage tank 57;
Maintaining a pressure at the intake 65 of the sodium circulation member 63 within a predetermined range by controlling a gas pressure in the sodium storage tank 57.

The sodium storage tank 57 is as described above.

The reaction vessel 59 is as described above.

The sodium feed circuit 61 is as described above.

The sodium storage tank 57 is fed with inert gas by a feed circuit 75 as described above.

The intake pressure of the sodium circulation member 63 is controlled within an effective range of 0 to 100 mbar.

The process, according to another aspect independent of the first, comprises the following steps:
Feeding liquid metallic sodium into a reaction vessel 59 containing an aqueous solution, the reaction vessel 59 having an aqueous solution outlet 121 submerged and opening below a nominal level of aqueous solution into the reaction vessel (59);
Collecting the aqueous solution coming from the reaction vessel 59 in a drain tank 119, the aqueous solution flowing through a drain line 120 from the aqueous solution outlet 121 right to the drain tank 119, the drain line comprising a regulating closing member 177;
Controlling the closuring member 177 so as maintain the level of aqueous solution in the reaction vessel 59 within a predetermined range.

The reaction vessel 59 is as described above.

The aqueous solution outlet 121 is as described above with reference to FIG. 3.

The reaction vessel 59 is fed liquid metallic sodium from a storage tank 57 via a feed circuit 61. The tank 57 and the feed circuit 61 are advantageously as described above with reference to FIG. 2.

The drain tank 119 is as described above with reference to FIG. 3. The drain line 120 is as described above with reference to FIG. 3.

The regulating closing member 177 is as described above with reference to FIG. 3.

Same is controlled by the controller 79 by using measurements taken by a member 175 measuring the level of aqueous solution in the reaction vessel 59.

The predetermined range is chosen so that, when the level of aqueous solution remains within said range, the aqueous solution outlet 121 is constantly submerged.

A process of destruction of sodium, according to a third aspect independent of the first and second aspects, comprising the following steps:
Feeding liquid metallic sodium to a reaction vessel 59 containing an aqueous solution, the reaction vessel having an aqueous solution outlet (121);
Collecting the aqueous solution coming from the reaction vessel 59 in a drain tank 119, the aqueous solution flowing through a drain line 120 from the aqueous solution outlet 121 right to the drain tank 119;
Feeding an inert gas into the drain tank (119);
Diluting the gases coming from the drain tank 119 and releasing the diluted gases into the atmosphere.

The reaction vessel 59 is as described above with reference to FIG. 2.

The aqueous solution outlet 121 is an overflow outlet, or in other words, an overfull outlet. The outlet was described above with reference to FIG. 2.

The drain tank 119 is as described above, with reference to FIG. 2. The drain line 120 is as described above with reference to FIG. 2.

The drain tank 119 is fed with inert gas as described above.

The gases coming from the drain tank 119 are directed toward a gas treatment unit 141 of the type described above.

The gases coming from the drain tank 119 are likely to contain hydrogen, because the drain tank 119 is connected to an outlet for liquids coming from the overflow of the reaction vessel 59. In the gas treatment unit 141, the gases coming from the drain tank 119 are diluted with a dilution ratio ensuring that the concentration of hydrogen after dilution excludes any risk of explosion.

What is claimed is:

1. A radioactive metal sodium destruction installation comprising:
a reaction vessel containing an aqueous solution, the reaction vessel having an aqueous solution outlet;
a sodium feed circuit configured for feeding liquid metallic sodium into the reaction vessel;
a liquid effluent treatment unit comprising a drain tank and a drain line fluidically connecting the aqueous solution outlet to the drain tank;
a gas treatment unit configured for diluting gases and releasing the diluted gases into the atmosphere, the drain tank having a gas outlet fluidically connected to the gas treatment unit; and
an inert gas feed unit configured for feeding an inert gas into the drain tank.

2. The installation according to claim 1, wherein the aqueous solution outlet is an overflow outlet.

3. The installation according to claim 1, wherein the installation comprises a control member configured for maintaining an inert gas pressure in the drain tank above a predetermined minimum.

4. The installation according to claim 1, wherein a controller controls the inert gas feed unit so as to provide an inert gas sweeping in the drain tank with an inert gas flow-rate within a predetermined range.

5. The installation according to claim 1, wherein the drain line is configured for emptying completely into the drain tank, by gravity.

6. The installation according to claim 1, further comprising a hydrogen treatment circuit connected to the reaction vessel, equipped with at least one gas scrubber, the drain tank having a storage capacity comprised between:
a minimum volume equal to a nominal volume of aqueous solution contained in the reaction vessel plus a nominal volume of aqueous solution contained in the gas scrubber; and
a maximum volume equal to a production of sodium hydroxide over a period of 6 hours.

7. The installation according to claim 1, wherein the installation comprises an aqueous solution storage tank having a storage capacity greater than one production day of the installation at nominal treatment capacity.

8. The installation according to claim 7, wherein the installation comprises a transfer member having an intake connected to the drain tank and a discharge connected to the aqueous solution storage tank.

9. The installation according to claim 8, wherein the drain tank is at least partially located below ground level and the aqueous solution storage tank is located above a ground level.

10. A process for destruction of sodium in a fast-neutron nuclear reactor, the process comprising:
feeding liquid metallic sodium into a reaction vessel containing an aqueous solution, the reaction vessel having an aqueous solution outlet;
collecting the aqueous solution from the reaction vessel in a drain tank, the aqueous solution flowing through a drain line from the aqueous solution outlet right to the drain tank;
feeding an inert gas into the drain tank; and
diluting the gases coming from the drain tank, and releasing the diluted gases into the atmosphere.
